(19) United States
(12) Patent Application Publication
(10) Pub. No.: US 2003/0160348 A1
(43) Pub. Date: Aug. 28, 2003

(54) Method and device for the transport of continous moldings without tensile stress

(76) Inventors: Stefan Zikeli, Regau (AT); Friedrich Ecker, Timelkam (AT)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/275,851

(22) PCT Filed: Apr. 18, 2001
(86) PCT No.: PCT/EP01/04416

(30) Foreign Application Priority Data
May 12, 2000 (DE) 10023391.0

(51) Int. Cl. B29C 47/00; D01D 5/06; D01D 5/12; D01F 2/02

(52) U.S. Cl. 264/70; 264/557; 264/561; 264/562; 264/187; 264/203; 264/211.12; 264/233; 264/210.3; 264/210.8; 425/71; 425/377; 425/446

(57) ABSTRACT

The invention relates to a method for producing extruded, cellulosic continuous shaped bodies from an extrusion solution containing cellulose, water and tertiary amino-oxide. In order to improve the textile properties of the extruded continuous shaped bodies with regard to the prior art, the invention provides that the continuous shaped body (5) is conveyed, with essentially no tensile stress, on a conveying device (11) between an extrusion nozzle opening and a take-off unit (24). To this end, the speed of conveyance of the interconnected conveying device (11) is preferably less than the extrusion rate and less than the take-off rate of the take-off unit (24). By employing these measures, the textile properties such as loop strength and tendency to fibrillate can be considerably improved.

The invention relates to a process for the manufacture of cellulose continuous moldings such as filaments, staple fibers, membranes and films in which an extrusion solution containing water, cellulose and tertiary amine oxide is extruded into at least one continuous molding and the continuous molding is then stretched, then the continuous molding is picked up on a conveying device and pulled by the conveying device through a draw-off unit.

The invention further relates to a device for the manufacture of cellulose continuous moldings such as filaments, staple fibers, membranes and films, from an extrusion solution containing water, cellulose and tertiary amino oxide, with at least one extrusion die opening through which the extrusion solution flows and downstream of which the extrusion solution is extruded into a continuous molding, and with a draw-off unit through which a tensile stress can be applied to the continuous molding and the continuous molding can be drawn out of the device.

In the state of the art, the dimensions of the extruded continuous moldings after coagulation and stabilization are set by the application of tensile stress. The tensile stress is created by the draw-off unit which takes hold of the continuous molding, draws it off and forwards it to further process stages.

Thus with the process and the device that are shown in WO 93/19230, a combination of a large number of continuous moldings is grouped together in the form of strands after emerging from a spin nozzle surface via a deflector roller and drawn off. The deflector roller is located in a precipitation bath.

The marked deflection of the continuous moldings at the deflector roller in the coagulation bath places a high mechanical load on the threads. This leads to impairments of the fiber quality, so that the process and device in WO 93/19230 create fibers which are inclined to brittleness, fibrillation and filament breakage.

Because of the deflection within the coagulation bath, the device and the process in WO 93/19230 are subjected to limitations in terms of the speed of the strand in the coagulation bath because of the viscosity of the coagulation bath.

To avoid this problem, with the process and the device in WO 96/30566, the continuous molding is taken through a coagulation liquid film. To remove the coagulation liquid from the continuous molding, this molding is suddenly turned through an angle between 45° and 60° at the lower end of the overflow.

With the process and device in WO 96/30566, the continuous molding is affected from the extrusion die opening onwards by a tensile stress caused by the mechanical fiber draw-off tool.

Because of the high mechanical loading due to the tensile stress and the sudden turn, the fibers obtained through the process and device of WO 96/30566 demonstrate poor textile characteristics. In particular, the tendency to fibrillation, the loop strength and the crimping behaviour leave much to be desired.

With the process and the device in EP 0 617 150 A1, viscose spinning filaments are drawn off in the form of a continuous cable using rollers, guided across several rollers and then taken to a belt conveyor to create a spun-bonded fabric. With this procedure, the deliberate aim is the formation of a fabric. Because of the formation of random layers and the hooking of the filaments, this system is not suitable for making staple fibers.

With this system too, fibers are created which only present moderately good fiber characteristics.

In consideration of the disadvantages of the state of the art, the object of the invention is therefore to provide a process and a device through which the textile characteristics of continuous moldings such as staple fibers and filaments can be improved. In addition, the process and the device are based on the object of lowering the tendency of the fibers to fibrillate and to increase loop strength.

This objective is achieved for the above-mentioned process according to the invention in that the continuous moldings are taken up after molding on a conveyor device and conveyed on the conveyor device to the draw-off unit essentially without tensile stress.

With the device, the object is solved according to the invention in that between the extrusion die opening and the draw-off unit a conveyor device is provided through which the continuous molding can be conveyed essentially without tensile stress to the draw-off device.

According to the invention, the continuous molding is therefore conveyed essentially without tensile stress in an area in which it consolidates and stabilizes or can relax. Surprisingly it has been found that the textile characteristics of the continuous molding are considerably improved by this type of process and device if no mechanically applied tensile stresses affect the continuous molding specifically in the critical area after molding.

Since in the area of the conveyor device the extruded continuous molding coagulates and stabilizes, stresses acting upon the continuous molding have a particularly strong effect on the mechanical characteristics of the continuous molding. This effect is minimized according to the invention.

The device according to the invention and the process according to the invention can be used both for the manufacture of films, filament composites and membranes and for the manufacture of staple fibers. If the invention is applied in spinning technology, the continuous molding is a strand and the extrusion die opening is a spinning nozzle opening.

With the process according to the invention and the device according to the invention, normally a large number of continuous moldings are processed simultaneously. Since all continuous moldings are processed in the same way in parallel, the process and device will be shown for the sake of simplicity only using one single continuous molding as an example. It is expressly proposed that a large number of continuous moldings goes through the same process stages at the same time and is processed by the device.

Conveyor devices in the area of spinning technology which convey essentially without tensile stress are already known. However, these conveyor devices are not suitable to improve the textile properties of the extruded matter conveyed on them.

DE 29 50 015 A1, for example shows a vibrating conveyor which conveys a fiber cake through a washing device. However, this vibrating device is positioned in the direction of extrusion of the continuous molding behind a draw-off unit. Thus, the continuous molding of DE 29 50 014 A1 as well is drawn from the extrusion die under mechanically applied tensile stress. As explained above, this has a disadvantageous effect on the textile properties of the continuous molding.

In the area in which the vibrating conveyor of DE 29 50 014 A1 is positioned, the textile properties of the continuous molding can no longer be influenced. The vibrating conveyor described therein is only used for washing out the fibers.

In WO 98/07911, a device and a process are described which are used to manufacture nonwoven fabrics. For this, at an extrusion die in the form of a spinning nozzle, the extruded strands are pulled and cut immediately after their emergence using strong air flows. These short fibers then fall randomly on a belt conveyor on which they coagulate into a nonwoven fabric.

The process and the device in WO 98/07911 are not comparable with the process according to the invention and the device according to the invention, since no continuous moldings can be formed. In addition, the process and the device as described in WO 98/07911 are not suitable for the manufacture of even fiber characteristics. This can be seen in the very high titre fluctuations and in the uneven values for the tensile and loop strengths. Because of the random position of the individual filaments and the necessary transfer to staple fiber through cutting the continuous filaments, no uniform cut lengths can be achieved—there is a wide range of scatter in the cut lengths.

The aim of the present invention is to improve the mechanical characteristics of each individual molding. According to the invention, the continuous molding is not cut during its transport to the draw-off unit. The mechanical characteristics of the nonwoven mat in WO 98/07911, on the other hand, are considerably affected by the nature of the random position and not by the characteristics of the individual cut strands.

Conveyance of the continuous molding without tensile stress on the conveyor is possible in a way that is particularly advantageous if, in a further embodiment of the process or the device, the continuous molding is transported on the conveyor device at a transport speed that is less than the extrusion speed of the continuous molding. The lower transport speed ensures that no tension is applied to the continuous molding. As a consequence, the continuous molding can relax during transport and be removed by a draw-off unit after relaxation and taken to a cutting machine.

In a further advantageous embodiment of the process or the device, the continuous molding can be drawn off by the draw-off unit with a draw-off speed which is essentially the same as the extrusion speed of the continuous molding. With this embodiment, the conveyor device thus forms a type of interim buffer zone, in which the extruded continuous molding is transported without stress. The high draw-off speed of the draw-off unit ensures that the buffer area does not overflow and the processing speed of the further processing stages behind the draw-off device corresponds to the extrusion speed.

It is also particularly beneficial if the continuous molding is transported on the conveyor device by the movement to and fro of the conveyor device preferably crossways to the direction of transport. In particular, the conveyor device may be built as a shake, oscillation or vibration conveyor.

Because of the reciprocating movement of the conveyor device, it is also possible in a further embodiment to use this movement necessary to convey the continuous molding at the same time to deposit the continuous molding in a geometrical position in the form of continuous molding cake on the conveyor device. The continuous molding arrives on the moving conveyor device and due to the relative movement between the continuous molding and the conveyor device, is automatically positioned in a wave form or in a wide manner so that the molding can relax properly. In addition, conveying the continuous moldings in a stress-free, swollen state allows optimum development of the fiber crimping, which is an important criterion in the further processing of staple fibers in particular.

To adapt the conveying speed of the conveyor device to the extrusion speed and/or draw-off speed and/or various operating parameters such as continuous molding quality and dimension, a further advantageous embodiment can contain a control device, which affects the conveyor device and through which the lift and/or the frequency of the movement of the conveyor device and/or deposit device can be adjusted. Sensors can also be provided, which monitor the extrusion speed, the draw-off speed, the quality and/or dimensions of the continuous molding and allow a control circuit to be built up to control the conveyor device.

Particular attention must be paid during staple fiber and filament manufacture to the even deposit of the continuous moldings after the spinning process, to prevent any looping of the individual filaments. This is particularly important with the production of staple fibers in order to obtain a good, even cutting length distribution. To even out the depositing of the continuous molding on a transport surface of the conveyor device, a guide device which is stationary at least in phases or which moves with the conveyor device can be provided, which the continuous molding hits and is thus guided onto the moving conveyor device. The continuous molding can be safely caught by the guide device and passed on to the conveyor device in a controlled way. Because of the relative movement between the guide device and the conveyor device the continuous molding is deposited in an orderly way in the direction of transport behind the guide device as a stacked, layered or folded continuous molding cake, as preferred.

In particular on the basis of the broad or wavy deposit of the continuous molding on the conveyor device, it is possible to lower the transport speed of the conveyor device in comparison with the extrusion speed and the draw-off device.

In a further embodiment, the continuous molding is transported by the guide device through a liquid bath, for example through a coagulation bath, which flows in the direction of transport. This minimizes the friction between the guide device and the continuous molding. Alternatively or additionally, the guide device can also have a particularly smooth surface and/or an anti-adhesion coating. The guide device and the conveyor device can be provided with bored holes to drain off the coagulation bath solution and/or grooves to guide the continuous molding. The guide plate can be located in the direction of gravity or the direction of extrusion directly underneath the extrusion die opening.

In a further embodiment, the continuous molding cake on the conveyor device can be transported through a number of zones, such as an infeed zone, a drainage zone, a washing zone and a post-treatment zone. These zones can be provided individually or on a multiple basis one after another in any combination.

In the infeed zone, the continuous molding cake is transported through a coagulation bath. The coagulation bath is located on the surface of the conveyor device and can be formed at least partly from the coagulation bath solution from the coagulation bath intake device.

In the washing zone, a washing medium is taken to the continuous molding cake on the conveyor device. This means that the continuous molding cake can be washed essentially without solvents. It is particularly advantageous if the washing medium in the washing zone flows against the direction in which the continuous mould cake is being transported.

In the drainage zone, the washing medium and/or the coagulation bath solution are drained from the conveyor device. The drained coagulation bath solution and/or the drained washing medium can be re-used and taken back into the process again.

Following the washing zone, the continuous molding can be post-treated in the same way in a post-treatment zone or be impregnated with a fatty coating. The drainage zone can be provided with perforations to drain off the coagulation bath or the washing medium. Underneath the perforations, collector basins may be positioned which collect the drained coagulation bath and/or the washing medium.

Preferably, with a conveyor device, the infeed zone in the direction of transport is in front of the drainage zone and the drainage zone is in front of the washing zone. In further advantageous embodiments, the transport area can have devices to improve the transport of the continuous molding cake. Thus limiting devices can be provided which rise up over the transport surface at the edges of the transport surface that run crossways to the direction of travel and limit this. The limiting devices prevent the continuous molding cake from falling off the conveyor device and allow an even lengthways adjustment of the deposited continuous moldings, which can be taken after the draw-off unit to a cutting machine to manufacture staple fibers.

This special embodiment of the transport surface has a positive effect on the even cutting length of the staple fibers.

In addition, the transport area may have conveyor grooves in which the continuous molding cake is guided and transported. This is an advantage in particular if a large number of continuous moldings is manufactured at the same time.

In order to allow easy removal of the large number of extruded continuous moldings at the end of the conveyor device by the draw-off unit, an extrusion die can be allocated to each conveyor groove. In particular, a single conveyor groove can be provided for each extrusion die. This avoids a tangle being created in the spinning cake which cannot then be disentangled.

The conveyor grooves may have an essentially rectangular or an essentially V-shaped cross-section. The cross-section design of the conveyor grooves may also have other shapes, depending on other requirements.

In the following the process according to the invention and the device according to the invention are described using two examples with reference to the figures. The invention is explained by way of example for one process and one device for the manufacture of strands. However, the invention is not limited to this application; in fact, films, membranes, hollow membranes and staple fibers can be made by the invention without alterations without any particular modifications to the conveyor device being required.

The figures show the following:

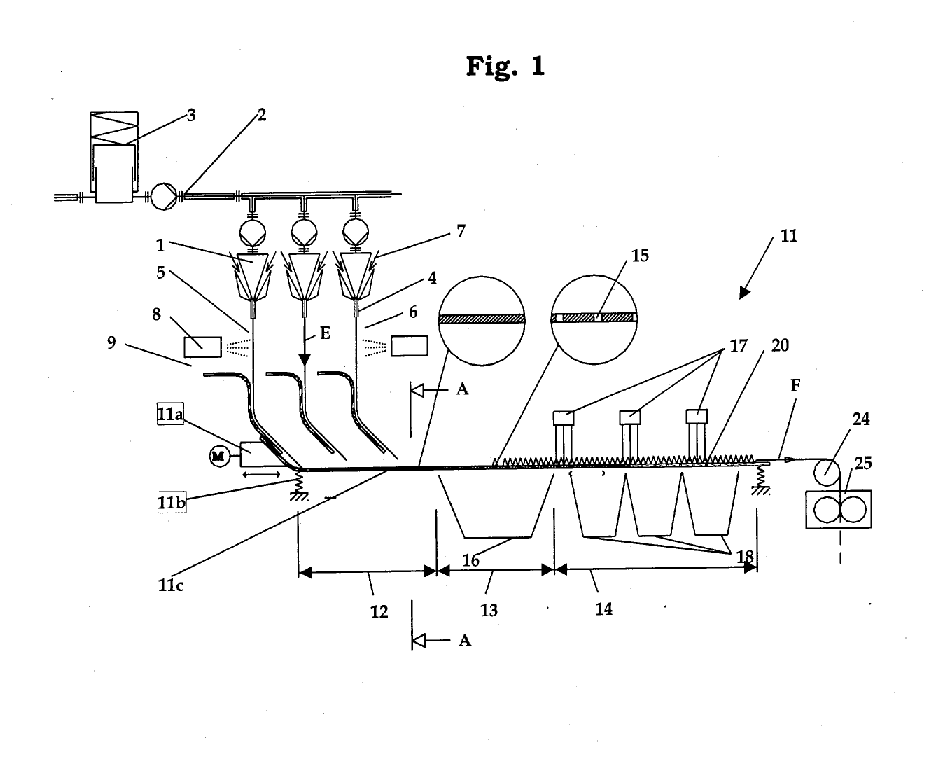

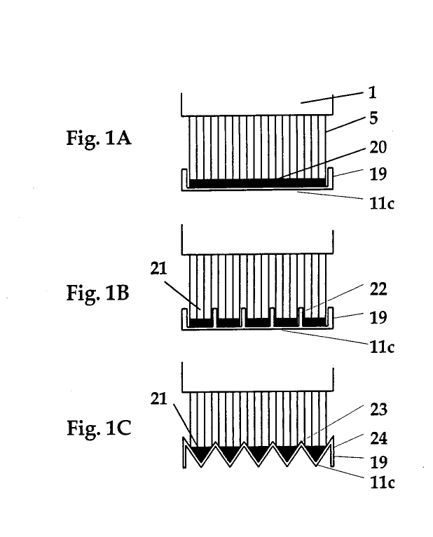

FIG. 1 A first embodiment of a device according to the invention for carrying out the process according to the invention;

FIG. 1A A first variant of the embodiment in FIG. 1 in a section along the line A-A in FIG. 1;

FIG. 1B A second variant of the embodiment in FIG. 1 in a section along the line A-A in FIG. 1;

FIG. 1C A second variant of the embodiment in FIG. 1 in a section along the line A-A in FIG. 1;

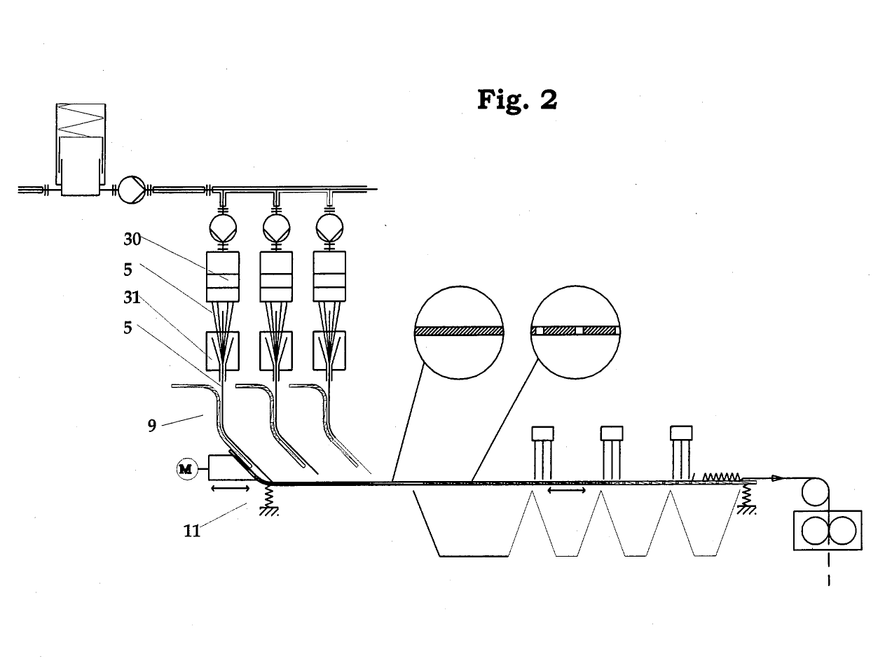

FIG. 2 A second embodiment of the device according to the invention for carrying out the process according to the invention.

The embodiment in FIG. 1 shows a series of heads 1 as extrusion heads which are supplied via a heating pipeline system 2 with a viscous extrusion solution. In order to guarantee a continuous supply to the spinning heads 1, the pipeline system 2 contains a buffer container 3, which evens out the volume flow and pressure fluctuations in the pipeline system 2 before the extrusion heads.

The extrusion solution used in the first embodiment is a spinning mass consisting of 15% Cellulose Type MoDo Crown Dissolving—DP 510 to 550, 75% NMMO (N-Methyl-Morpholin-N-Oxide) and 10% water. The temperature of the extrusion solution in the pipeline system 2 is 100° C. The zero shearing viscosity level of the shearing solution according to the first embodiment is 7900 Pas.

Each of the spinning heads 1 has at least one heated spinning capillary 4, preferably a large number of spinning capillaries 4 in a single row. The spinning capillaries are small pipes made from chromium-nickel steel with an internal diameter in the area of 250 μm and a length of about 20 mm. The length-diameter (L/D) ratio is around 80. Spinning capillaries with a considerably larger L/D ratio may also be used. The distance between the middle axes of the spinning capillaries of a spinning head is approx. 1 mm.

The mass flow per spinning capillary is around 0.10 g per minute. The spinning capillaries are heated using hot water to a temperature of around 150° C.

The spinning capillaries 4 end in an extrusion die opening (without reference) from which the spinning mass emerges in the form of a strand 5 as an extruded continuous molding.

The continuous moldings 5 extruded through the extrusion die opening pass through an air gap or a gas section 6. In the gas section 6, the continuous molding 5 is stretched using air 7 which flows out of the spinning or extrusion head 1 parallel to the strand axis along the continuous molding 5. The speed of the air 7 is greater than the extrusion speed of the strand. At a temperature of about 30° C., the relative humidity of the air 7 is around 70%. The spinning or extrusion die opening may have a round or a rectangular cross-section.

After passing through the gas section 6, the extruded and stretched continuous molding is sprayed by a sprinkler device 8 with coagulation bath solution. The sprinkler device may be built as a spray or mist chamber. The sprinkler device supplies exactly the amount of moisture to prevent an adhesion of the continuous moldings emerging from the large number of extrusion die openings in the form of a curtain.

After passing through the sprinkler device 9, each continuous molding 5 meets a guide device 9 which is positioned directly below the extrusion die opening in the direction of extrusion E. The guide device of the embodiment in FIG. 1 is embodied as a guide plate 9, which is supplied continuously with a coagulation bath solution 10 which flows in the extrusion and stretch direction of the continuous molding 5 at the continuous molding supply device under the effect of gravity. The coagulation bath film means that the continuous moldings 5 running up to the guide plate 9 can be transported with less damage.

If, as is shown in FIG. 1, several rows of spinning heads 1 are provided, a separate guide device 9 can be assigned to each of these rows.

A conveyor device 11 adjoins the guide device 9 in the direction of transport of the continuous molding. The conveyor device 11 is designed as a vibrating conveyor device and has an electromechanical unbalance drive 11a, elastic bearings 11b and a transport area 11c. In the embodiment shown in FIG. 1, only one conveyor device 11 is shown. The stroke or amplitude and the frequency of the drive 11a are controlled by a control device (not shown) and can be adjusted by hand or automatically depending on process parameters such as the quality and composition of the extruded matter, the extrusion speed, the dimensions of the extrusion die and the temperatures of the extrusion solution.

If necessary, any number of conveyor devices 11 can be combined one after another in the direction of transport. The transport surface 11c has three areas, 12, 13 and 14. A first area 12 in the direction of transport is made as the infeed zone, in which the coagulation bath solution 10 from the continuous molding supply device 9 collects and is transported on in the direction of transport F.

In the second area following the infeed zone 12 in the direction of transport, a drainage area 13, the transport surface 11c is provided with perforations 15. The drainage area 13 is part of the spinning area and serves to drain off the coagulation bath solution supplied during the spinning process through the perforations 15 from the conveyor device 11. For this, underneath the perforations 15 a collector basin 16 is provided in which the coagulation bath solution is collected and then taken back to the guide device 9 and/or the infeed zone 12 or sprinkler device 8.

In the direction of transport F of the conveyor device 11, the drainage zone 13 is followed by the third area 14, a washing zone. The washing zone 14 has at least one washing device 17 which supplies a washing medium to the continuous molding on the transport surface of the conveyor device 11. In addition, one or more washing devices can also be used for the application of a fatty coating or other post-treatment, wetting or bleaching chemicals to the continuous moldings.

The washing medium washes the continuous molding cake without solvents and in the embodiment in FIG. 1 applies a 10 g/l finish (50% Leomin OR-50% Leomin WG-nitrogenous fatty acid polyglycol ester made by Clariant GmbH) at 45° C. The fatty coating is applied to give better fiber processing.

The transport surface may also be perforated in the washing zone area.

Underneath the perforations in the transport surface in the area of the washing zone 14 are collector basins 18 which may be part of the washing device. The washing medium taken in counterflow to the transport surface 11c is collected in the collector basins 18 and taken back to the washing devices 17.

The transport surface 11c is built in the embodiment in FIG. 1 as an essentially horizontal surface. The surface of the transport surface, like the surface of the strand guide plate 9, is polished and/or coated in order to minimise the adhesion of the continuous molding to the surface of the transport surface.

The transport surface basically extends in a horizontal direction and is moved to and fro in an oscillating movement in the direction of transport through the unbalance drive 11a. The vibration of the transport surface 11c may be periodical or quasi-periodical and sinusoid or zigzag shaped.

FIGS. 1A to 1C shows a sectional view of the transport surface 11c along the line A-A of

In the variant in FIG. 1A, the transport surface 11c has, at the two edges located vertically to the direction of transport, limiting devices 19 which rise above the surface of the transport surface 11c. The limiting devices 19 are used to guide the continuous molding cake 20 on the transport surface 11c.

In the second variant according to FIG. 1B, the transport surface 11c contains in addition to the limiting devices 19 conveyor grooves 21 which are separated from each other through struts 22. In the area above the struts 22 there are no extrusion die openings. The spinning cake is guided through the conveyor grooves 21 and divided into individual parts.

If rectangular dies are used which are oriented in a horizontal direction transverse to the direction of travel F of the continuous molding cake 20, no extrusion die openings may be provided above the struts 22 in the direction of extrusion and stretching.

In the third variant according to FIG. 1C, the conveyor grooves 21 are made in a V shape. Once again, there is no extrusion die opening above the separating area 23, so that the continuous moldings 5 are always deposited in a conveyor groove 21.

The extrusion die openings can be positioned both crossways to the direction of travel and also in the direction of travel of the continuous molding cake.

Because of the vibrating movement of the transport surface 11c in the direction of transport F, each continuous molding 5 supplied by the continuous molding supply device is deposited in a geometrically orderly layer, for example in the form of wave-shaped stacks, on transport surface 11c.

Because of this folded or wavy deposition of the continuous molding 5, it is possible to considerably reduce the transport speed of the conveyor device 11 compared to the extrusion speed of the continuous molding. In the embodiment in FIG. 1, the processing speed is 50 to 150 times the transport speed of the conveyor device 11.

At the end of the conveyor device 11, the continuous molding deposited in a wave shape in the form of a spinning cake 20 is unfolded using a draw-off unit 24, drawn off and accelerated back to extrusion speed.

A cutting machine 25 can then be provided following the draw-off unit. The cutting machine 25 then cuts the continuous moldings 7 into stacks which subsequently are dried at approx. 105° C.

The strands created by the embodiment in FIG. 1 have a fineness of approx. 1.5 dtex and a staple length of approx. 40 mm.

After drying, the strand moisture is set at approx. 10%. Further treatment options for the continuous molding such as creation of an increased strand crimp and filament drying can also be added.

Additional bleaching before drying is not carried out in the embodiment in FIG. 1.

In the area of the transport surface 11c, press devices (not shown) can be provided which press or drain the continuous molding cakes.

The textile characteristics of the continuous moldings according to the embodiment in FIG. 1, measured using the normal standardised procedures, were as follows:

The tearing strength dry was around 40 cN/tex; elongation at break dry was approx. 13%; loop tearing strength was more than 17 cN/tex and the fibrillation grade was 2.

According to this, the textile characteristics are considerably better than the state of the art.

Spraying by a coagulation bath solution using the sprinkler devices 8 can also be left out within the framework of the present invention without any major negative effect on the textile characteristics.

FIG. 2 shows a second embodiment of the invention.

The following will only discuss the differences from the first embodiment in FIG. 1, for the sake of simplicity.

Instead of the heated spinning capillaries, the embodiment in FIG. 2 uses a circular nozzle 30 with a small cap. The nozzle has a hole index of around 8500, and the individual capillary has a diameter of 100 μm. The external diameter of the circular nozzle is approx. 80 mm.

Every continuous molding or strand 5 from the circular nozzle 30 passes firstly through an air gap 6 and then runs directly into a spinning funnel 31.

The spinning funnel 31 is located in a coagulation bath, whereby the spinning bath supply is set in such a way that part of the spinning bath liquid always overflows at the upper edge of the funnel.

The continuous molding groups emerging from the spinning funnel are positioned on the conveyor device 11 without further stretching, according to the continuous molding as in embodiment 1.

This means as regards the function of the conveyor device, there is no difference between an individual strand and a strand group. Both the strand and the strand group are continuous moldings as defined in the invention.

The circular nozzles 30 and the spinning funnels 31 may be positioned both lengthways and crossways in relation to the direction of transport of the conveyor device. In particular, circular nozzles and spinning funnels 30, 31 can be arranged in a grid shape.

The spinning speed of the embodiment in FIG. 2 is 30 m/min with a titre of approx. 3.8 dtex.

The textile characteristics of the strands are also superior to the state of the art if circular nozzles are used. The tearing strength dry is more than 29 cN/tex with an elongation at break of approx. 15% dry. The loop tearing strength is approx. 8.5 cN/tex and the fibrillation grade 1.

In both embodiments, the transport speed that is lower than the extrusion speed and the draw-off speed achieves a tensile stress free transport of the continuous moldings as individual continuous moldings or as continuous molding groups in a continuous molding cake.

The continuous moldings made using the device according to the invention can be used for the manufacture of packaging and fiber material, as mix components for the manufacture of yarns or to make nonwoven and woven fabrics.

In the further processing of the continuous moldings made using the process according to the invention and the device according to the invention, additional components such as cotton, Lyocell, Rayon, Carbacell, polyester, polyamide, cellulose acetate, acrylate, polypropylene or mixtures hereof can be added at up to 30% by weight.

We claim:

1. Process for the manufacture of cellulose moldings such as filaments, staple fibers, membranes and films covering the following process steps:
extrusion of an extrusion solution containing water, cellulose and amine oxide into at least one continuous molding (5),
stretching the continuous molding (5) through a fluid flow conducted in the extrusion direction (E), said fluid flow flowing around the continuous molding (5),
taking up the continuous molding (5) on a conveyor device (11),
conveying the continuous molding (5) essentially without tensile stress on the conveyor device (11) to a draw-off unit (24) with simultaneous coagulation and solidification of the continuous molding (5), and
pulling off the continuous molding from the conveyor device with tensile stress exerted by the draw-off unit.

2. Process according to claim 1 in which the following process stage is carried out:
conveying the continuous molding (5) on the conveyor device (11) with a transport speed which is lower than the extrusion speed of the continuous molding (5).

3. Process according to claim 1 or 2 in which the following process step is carried out:
drawing off the continuous molding (5) by the draw-off unit (24) with a draw-off speed which is essentially the same as the extrusion speed of the continuous molding (5).

4. Process according to one of the above-mentioned claims in which the following process step is carried out:
conveying the continuous molding (5) on the conveyor device (11) by means of oscillating movement of the conveyor device (11) preferably in the direction of transport (F).

5. Process according to claim 4 in which the following process step is carried out:
controlling the amplitude and/or frequency of the movement of the conveyor device (11) as a function of at least the constitution of the continuous molding (5) and the extrusion speed.

6. Process according to one of the above-mentioned claims in which the following process step is carried out:
orderly depositing of the continuous molding (5) as a continuous molding cake (20) on the conveyor device (11).

7. Process according to one of the above-mentioned claims in which the following process step is carried out:
supply of the continuous molding (5) to the conveyor device (11) by a guide device which is at least partially stationary.

8. Process according to one of the above-mentioned claims in which the following process step is carried out:
transport of the continuous molding (5) by the guide device (9) in a liquid flowing in the direction of transport (F), preferably consisting of a coagulation bath solution.

9. Process according to one of the above-mentioned claims in which the following process step is carried out:
conveying the continuous molding cake on the conveyor device (11) through a coagulation bath in an infeed zone following the guide device (9).

10. Process according to one of the above-mentioned claims in which the following process step is carried out:
conveying the continuous molding cake on the conveyor device (11) through a drainage zone (13) in which the coagulation bath solution is drained off from the conveyor device (11).

11. Process according to one of the above-mentioned claims in which the following process step is carried out:
conveying the continuous molding cake on the conveyor device (11) through a washing zone in which a liquid washing medium is taken to the conveyor device (11) and the continuous molding (5) is washed essentially without solvents.

12. Process according to claim 11 in which the following process step is carried out:
supplying the washing medium in the washing zone in a counter-flow in the opposite direction to the direction of transport (F).

13. Process according to one of the above-mentioned claims in which the following process step is carried out:
draining the washing medium in the washing zone.

14. Process according to one of the above-mentioned claims in which the following process step is carried out:
pressing the continuous molding (5) on the conveyor device.

15. Process according to one of the above-mentioned claims in which the following process step is carried out after stretching:
taking the continuous molding (5) through a gas section.

16. Process according to one of the above-mentioned claims in which the following process step is carried out:
spraying the continuous molding (5) in the gas section (6) with a coagulation bath solution.

17. Device for the manufacture of cellulose moldings such as filaments, staple fibers, membranes and films with at least one extrusion die opening through which during operation an extrusion solution comprising cellulose, water and tertiary amine oxide emerges and is extruded into a continuous molding (5) and with a draw-off unit (24) through which the continuous molding (5) can be drawn off with the application of tensile stress, and between the extrusion die opening and the draw-off unit a conveyor device (11) is provided through which the continuous molding (5) in operation can be conveyed to the draw-off unit essentially without tensile stress, wherein between the extrusion die opening and the conveyor device the continuous molding is flown around and drawn by a fluid flow conducted in the extrusion direction (E).

18. Device according to claim 17 to 19, wherein the conveyor device (11) is made as a vibrating conveyor which, in operation is driven reciprocatingly essentially in the direction of transport (F).

19. Device according to claim 17 or 18, wherein the device has a control device connected with the conveyor device (11) through which the life and/or frequency of the movement of the conveyor device (11) can be set.

20. Device according to one of claims 17 to 19, wherein the conveyor device (11) has a transport surface (11c) to take up and further transport the continuous molding (5).

21. Device according to claim 20, wherein the transport surface (11c) is directed upwards and is located essentially underneath the extrusion die opening in the direction of gravity or in the direction of the extrusion (E).

22. Device according to one of claim 20 or 21, wherein the continuous molding (5) lies in an essentially orderly manner on the transport surface (11c) as a continuous molding cake (20).

23. Device according to one of claims 20 to 23, wherein the transport surface (11c) is provided with at least one conveyor groove (21) running in the direction of transport (F).

24. Device according to claim 23, wherein if there is a large number of conveyor grooves and extrusion die openings, each conveyor groove (21) is assigned to one extrusion die opening.

25. Device according to claim 23 or 24, wherein if there is a large number of extrusion die openings and conveyor grooves, exactly one conveyor groove (21) is assigned to each extrusion die.

26. Device according to one of claims 23 to 25, wherein the conveyor groove (21) has an essentially V-shaped or rectangular cross-section.

27. Device according to one of the claims 20 to 26, wherein the transport surface (11c) is provided in the direction transverse to the direction of transport (F) with limiting devices rising above the transport surface (11c).

28. Device according to claim 27, wherein the limiting device (19) is perforated at least in sections.

29. Device according to one of claims 17 to 28, wherein the conveyor device (11) has an area configured as an infeed zone (13) in which the continuous molding (5) is affected by a coagulation bath.

30. Device according to one of claims 17 to 29, wherein the transport surface (11c) has an area configured as a washing zone in which a washing device is positioned through which a washing medium can be supplied to the washing zone.

31. Device according to one of claims 17 to 30, wherein the transport surface (11c) is provided with an area configured as a drainage zone (13) having perforations to drain off the coagulation bath or the washing medium from the conveyor device (11).

32. Device according to one of claims 17 to 30, wherein in the direction of transport (F) of the continuous molding (5), preferably immediately in front of the conveyor device (11) a guide device (9) which is essentially unmoving in respect of the extrusion head (1) is provided which is impacted by the continuous molding (5) and through which it is guided towards the moving conveyor device (11).

33. Device according to claim 32, wherein the continuous molding supply device has a coagulation bath film flowing in the direction of transport (F) in which the continuous molding (5) is taken.

34. Device according to one of claims 17 to 33, wherein between the extrusion die opening and the conveyor device (11) a gas section (6) is located in which the continuous molding (5) is surrounded by a fluid flow guided in the direction of extrusion (E) and stretched.

35. Device according to one of claims 17 to 34, wherein between the extrusion die opening and the conveyor device (11) a sprinkler device is provided through which in operation the continuous molding (5) can be sprinkled with a coagulation bath.

36. Device according to one of claims 17 to 35, wherein the conveyor device (11) is provided with a pressing device through which the continuous molding (5) is pressed on the transport surface (11c).

37. Use of the continuous molding manufactured according to one of the claims 1 to 16 in the form of fiber material as mix components to manufacture yarns.
